(19) United States
(12) Patent Application Publication
(10) Pub. No.: US 2014/0234674 A1
(43) Pub. Date: Aug. 21, 2014

(54) SECONDARY BATTERY

(71) Applicant: Mizuho Matsumoto, Toyota-shi (JP)

(72) Inventor: Mizuho Matsumoto, Toyota-shi (JP)

(73) Assignee: TOYOTA JIDOSHA KABUSHIKI KAISHA, Toyota-shi, Aichi (JP)

(21) Appl. No.: 14/346,165

(22) PCT Filed: Sep. 21, 2011
(86) PCT No.: PCT/JP2011/005316

§ 371 Date: Mar. 20, 2014

(51) Int. Cl. H01M 2/34

(52) U.S. Cl. CPC H01M 2/345
USPC 429/61; 429/179

(57) ABSTRACT

A secondary battery includes: a power generation element that charges and discharges; a battery case that houses the power generation element; and an electrode terminal that is exposed in an outer surface of the battery case and is electrically connected to the power generation element. The secondary battery includes a current cutoff mechanism and an auxiliary terminal. The current cutoff mechanism is disposed on a current path connecting between the power generation element and the electrode terminal inside the battery case and capable of cutting off an electric current. The auxiliary terminal is electrically connected to the current path positioned between the power generation element and the current cutoff mechanism of current paths and exposed in the outer surface of the battery case.

### TECHNICAL FIELD

The present invention relates to a secondary battery that includes a current cutoff mechanism for cutting off a current path inside the secondary battery.

### BACKGROUND ART

In Patent Document 1, a current cutoff mechanism is disposed inside the secondary battery. When internal pressure of the secondary battery rises in relation to overcharge of the secondary battery, an electric current is cut off by deformation of a metal plate included in the current cutoff mechanism. The current cutoff mechanism is connected to an electrode terminal, and thus charging and discharging through the electrode terminal is inhibited when the electric current is cut off in the current cutoff mechanism.

### PRIOR ART DOCUMENT

### Patent Document

Patent Document 1: Japanese Patent Application Publication No. 2010-157451 (JP 2010-157451 A)

### SUMMARY OF THE INVENTION

### Problem to be Solved by the Invention

After the electric current is cut off by the current cutoff mechanism, electric energy stored in the secondary battery cannot be drawn from the electrode terminal. The current cutoff mechanism operates by the overcharge of the secondary battery, and thus a large amount of electric energy is stored in the secondary battery.

### Means for Solving the Problem

A secondary battery that is the present invention includes: a power generation element that charges and discharges; a battery case that houses the power generation element; and an electrode terminal that is exposed in an outer surface of the battery case and is electrically connected to the power generation element. Additionally, the secondary battery includes a current cutoff mechanism and an auxiliary terminal. The current cutoff mechanism is disposed on a current path connecting between the power generation element and the electrode terminal inside the battery case and capable of cutting off an electric current. The auxiliary terminal is electrically connected to the current path positioned between the power generation element and the current cutoff mechanism of current paths and exposed in the outer surface of the battery case. Although the secondary battery includes a positive electrode terminal and a negative electrode terminal, the electrode terminal in the present invention is at least one terminal of the positive electrode terminal and the negative electrode terminal.

According to the present invention, after the electric current is cut off by the current cutoff mechanism, the power generation element can be discharged by using the auxiliary terminal. More specifically, the auxiliary terminal is connected to a load, and thus the electric current can flow through the load. By discharging the power generation element, the electric energy can be prevented from being held stored in the power generation element.

The current cutoff mechanism can irreversibly change its state from a conduction state to a state in which the electric current is cut off. Thus, when the current cutoff mechanism operates, the state in which the electric current is held cut off can be maintained. As the current cutoff mechanism, a valve that deforms in response to a rise in internal pressure of the battery case can be used. When the secondary battery is overcharged, a gas is generated inside the battery case, and the internal pressure of the battery case rises. In response to the rise in the internal pressure of the battery case, the current path can be interrupted by deforming the valve. The present invention is particularly effective in the structure in which the current cutoff mechanism (including the valve described above) is required to be disposed inside the battery case.

A through-hole that is used in filling an electrolyte solution can be formed in the battery case. The auxiliary terminal can be used as a member for blocking the through-hole. Consequently, the auxiliary terminal has a function of discharging the power generation element and a function of blocking the through-hole. The number of parts count can be prevented from increasing and the cost can be reduced by providing two functions to the auxiliary terminal. A blind rivet can be used as the auxiliary terminal, for example.

An area which is exposed in the outer surface of the battery case, of the auxiliary terminal can be covered with a cover that is made of an insulating material. When the secondary battery is charged and discharged with the electrode terminal, the auxiliary terminal is not used. Thus, the auxiliary terminal can be covered with the cover.

A projection part and a depression part can be formed in the area of the auxiliary terminal that is exposed in the outer surface of the battery case (exposed area). As a result of forming the projection part and the depression part in the exposed area of the auxiliary terminal, when the auxiliary terminal is connected to the load through wiring, the wiring can easily be connected to the auxiliary terminal. In other words, the wiring can easily be attached to the auxiliary terminal by using the projection part and the depression part. The projection part and the depression part can be formed with a thread groove, for example.

The battery case can be constructed with a case body that is formed into a shape corresponding to a rectangular parallelepiped and a lid that forms a housing space of the power generation element together with the case body. The case body has an opening for installation of the power generation element, and the lid blocks the opening of the case body. The electrode terminal and the auxiliary terminal can be fixed in the lid. The auxiliary terminal can be disposed on an outer edge side of the lid with respect to the electrode terminal. Consequently, when the auxiliary terminal is accessed from the outside of the secondary battery, the auxiliary terminal hardly interferes with the electrode terminal and becomes easily accessible.

### BRIEF DESCRIPTION OF DRAWINGS

FIG. 1 is an outline view of the secondary battery.

FIG. 2 is a diagram that shows an internal structure of the secondary battery.

FIG. 3 is a development view of the power generation element.

FIG. 4 is a side view of the power generation element.

FIG. 5 is a diagram that shows the structure of a part of the secondary battery in a used state in a first embodiment.

FIG. 6 is a diagram that shows the structure of a part of the secondary battery in a current cutoff state in a first embodiment.

FIG. 7 is a diagram that shows the structure of a part of the secondary battery in a modification of the first embodiment.

FIG. 8 is an outline view of the auxiliary terminal in the modification of the first embodiment.

FIG. 9 is a diagram that shows the structure of a part of the secondary battery that is a second embodiment.

FIG. 10 is a diagram that shows the auxiliary terminal in the modification of the second embodiment.

FIG. 11 is a diagram that shows the auxiliary terminal in another modification of the second embodiment.

### MODES FOR CARRYING OUT THE INVENTION

Hereinafter, embodiments of the present invention will be described.

### First Embodiment

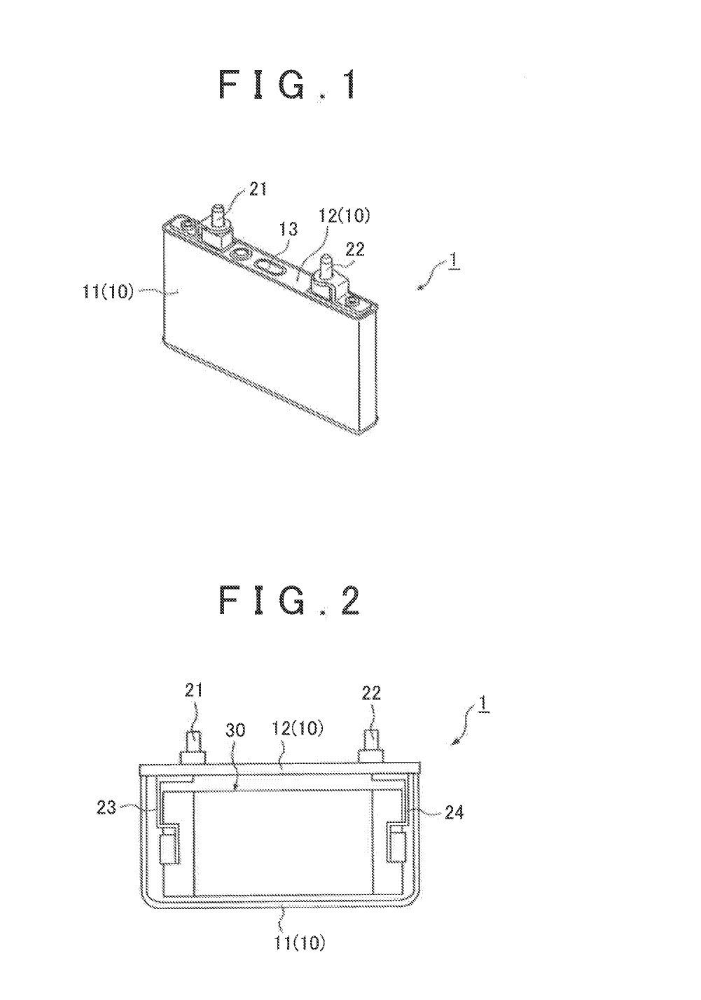

FIG. 1 is an outline view of the secondary battery that is a present embodiment. FIG. 2 is a schematic diagram that shows an internal structure of the secondary battery. Lithium ion secondary batteries or nickel-metal hydride batteries are used as the secondary battery 1, for example. The secondary battery 1 can be used as a power source for driving a vehicle. More specifically, electric power of the secondary battery 1 is supplied to a motor-generator, and thus the motor-generator can generate kinetic energy for driving the vehicle.

The secondary battery 1 has a battery case 10 and a power generation element 30 that is housed in the battery case 10. The battery case 10 has a case body 11 and a lid 12 and can be made of metal such as aluminum.

The case body 11 has an opening for installation of the power generation element 30 in the case body 11, and the lid 12 block the opening of the case body 11. The lid 12 is fixed on the case body 11 by welding and the like. The inside of the battery case 10 is in a tightly closed state. An electrolyte solution is also housed inside the battery case 10 besides the power generation element 30. The battery ease 10 is formed in a shape corresponding to a rectangular parallelepiped, and the secondary battery 1 is a so-called rectangular battery.

The lid 12 is provided with a valve 13. The valve 13 can be formed by carving on the lid 12. The valve 13 is used to discharge the gas generated inside the battery case 10 to the outside of the battery case 10. When the gas is generated inside the battery case 10 and the internal pressure of the battery case 10 rises, the valve 13 changes its state from a closed state to an open state. The pressure when the valve 13 changes its state from the closed state to the open state (operating pressure of the valve 13) can be appropriately determined in consideration of pressure-resistant performance of the battery case 10 and the like.

A negative electrode terminal (electrode terminal) 21 and a positive electrode terminal (electrode terminal) 22 are fixed on the lid 12. The negative electrode terminal 21 and the positive electrode terminal 22 have sections that are positioned outside the battery case 10 and sections that are positioned inside the battery case 10. A negative electrode tab 23 is housed in the battery case 10 and connected to the negative electrode terminal 21 and the power generation clement 30. A positive electrode tab 24 is housed in the battery case 10 and connected to the positive electrode terminal 22 and the power generation element 30.

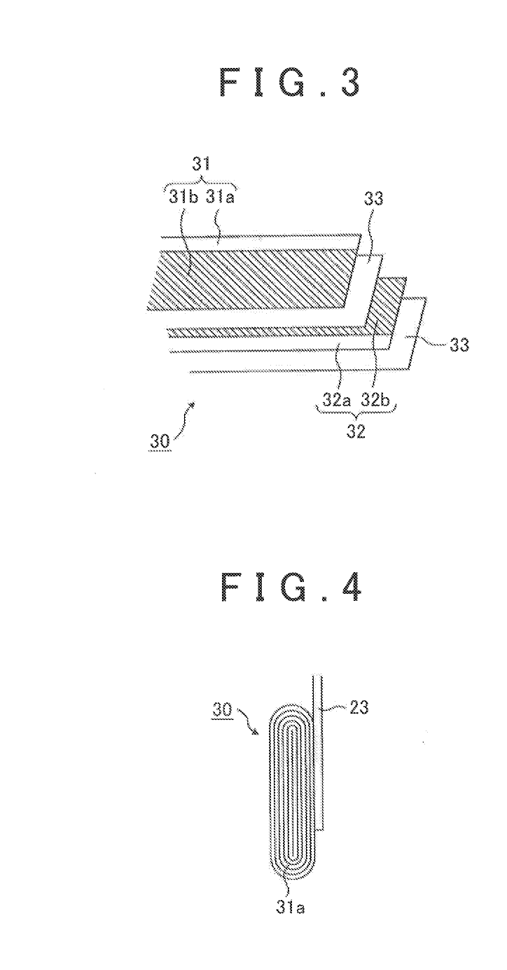

FIG. 3 is a view in which a part of the power generation element 30 is developed. The power generation element 30 is an element that is electrically charged and discharged. The power generation element 30 has a negative electrode plate 31, a positive electrode plate 32, and a separator 33.

The negative electrode plate 31 has a current collector plate 31a and a negative electrode active material layer 31b. The negative electrode active material layer 31b is formed on a surface of the current collector plate 31a and also formed on both sides of the current collector plate 31a. The negative electrode active material layer 31b is formed in one area of the current collector plate 31a, and the current collector plate 31a is exposed at an end of the negative electrode plate 31. The negative electrode active material layer 31b includes a negative electrode active material, a conductive material, a binder, and other materials.

When the lithium ion secondary battery is used as the secondary battery 1, carbon can be used as the negative electrode active material, for example. The current collector plate 31a can be made of copper, for example.

The positive electrode plate 32 has a current collector plate 32a and a positive electrode active material layer 32b. The positive electrode active material layer 32b is formed on a surface of the current collector plate 32a and also formed on both sides of the current collector plate 32a. The positive electrode active material layer 32b is formed in one area of the current collector plate 32a, and the current collector plate 32a is exposed at an end of the positive electrode plate 32. The positive electrode active material layer 32b includes a positive electrode active material, a conductive material, a binder, and other materials.

When the lithium ion secondary battery is used as the secondary battery 1, LiCoO₂, LiMn₂O₄, LiNiO₂, LiFePO₄, Li₂FePO₄F, LiCo_{1/3}Ni_{1/3}Mn_{1/3}O₂, or Li(LiₐNiₓMn_{y}Co_{z})O₂ can be used as the positive electrode active material, for example. The current collector plate 32a can be made of aluminum, for example.

The separator 33 is disposed between the negative electrode plate 31 and the positive electrode plate 32 and comes into contact with the negative electrode active material layer 31b and the positive electrode active material layer 32b. The electrolyte solution is impregnated into the separator 33, the negative electrode active material layer 31b, and the positive electrode active material layer 32b. The power generation element 30 has two separators 33, and the positive electrode plate 32 is disposed between two separators 33.

As shown in FIG. 3, a laminated body is formed by laminating the negative electrode plate 31, the positive electrode plate 32, and the separator 33. The power generation element 30 shown in FIG. 4 is formed by rolling the laminated body. FIG. 4 is a side view of the power generation element 30 that is seen from the side to which the negative electrode tab 23 is connected.

Only the negative electrode plate 31 (specifically, the current collector plate 31a) is rolled at one end of the power generation element 30, and the negative electrode tab 23 is welded onto the part where the current collector plate 31a is rolled, as shown in FIG. 4. The negative electrode tab 23 can be made of the same material as the current collector plate 31a. Consequently, the negative electrode tab 23 and the current collector plate 31a can easily be welded together.

Only the positive electrode plate 32 (specifically, the current collector plate 32a) is rolled at the other end of the power generation element 30, and the positive electrode tab 24 is welded onto the part where the current collector plate 32a is rolled. The positive electrode tab 24 can be made of the same material as the current collector plate 32a. Consequently, the positive electrode tab 24 and the current collector plate 32a can easily be welded together. The method for connecting the negative electrode tab 23 and the positive electrode tab 24 to the power generation element 30 may be the method other than welding.

In the structure shown in FIG. 4, the negative electrode active material layer 31b and the positive electrode active material layer 32b face each other with the separator 33 therebetween. When the secondary battery 1 is charged and discharged, ions move between the negative electrode active material layer 31b and the positive electrode active material layer 32b.

For example, when the secondary battery 1 as the lithium ion secondary battery is discharged, a chemical reaction in which lithium ions and electrons are released occurs in the negative electrode active material layer 31b. Additionally, a chemical reaction in which lithium ions and electrons are absorbed occurs in the positive electrode active material layer 32b. When the secondary battery 1 as the lithium ion secondary battery is charged, the chemical reaction in which lithium ions and electrons are absorbed occurs in the negative electrode active material layer 31b. Additionally, a chemical reaction in which lithium ions and electrons are released occurs in the positive electrode active material layer 32b.

The gas is generated inside the secondary battery 1 (battery case 10) by the overcharge of the secondary battery 1. The gas is generated by the thermal decomposition of the electrolyte solution, for example. The inside of the battery case 10 is in a tightly closed state, and thus the internal pressure of the battery case 10 rises due to the generation of the gas. The secondary battery 1 has a current cutoff valve. The current cutoff valve operates when the internal pressure of the battery case 10 rises to interrupt the current path that is used for charging and discharging of the secondary battery 1. Thus, the overcharge of the secondary battery 1 and the like can be prevented.

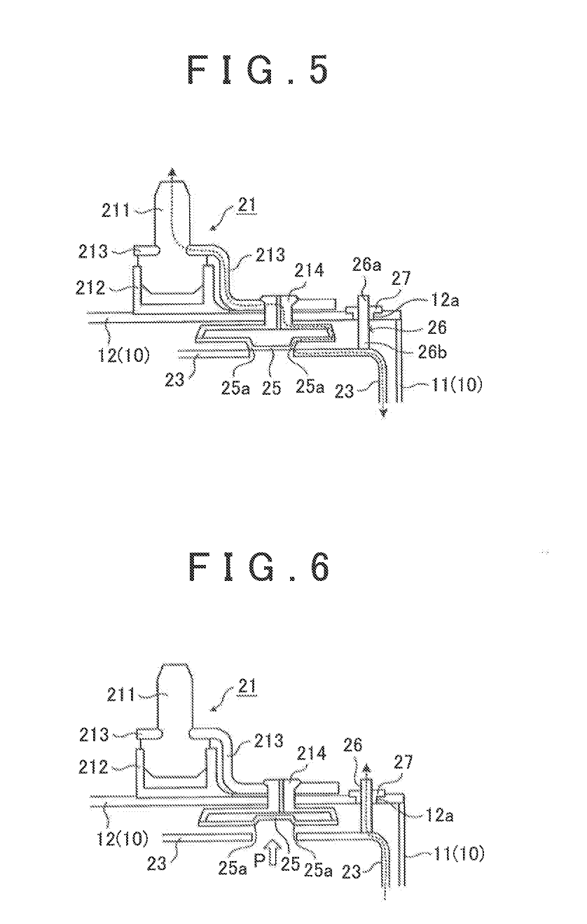

The structure of the current cutoff valve is described with reference to FIG. 5. FIG. 5 is a cross-sectional view that shows the structure of a part of the secondary battery 1.

The negative electrode terminal 21 has a terminal body 211, a terminal pedestal 212, a terminal lead 213, and a fixing member 214. The terminal body 211 is connected to a load or another secondary battery 1. When an assembled battery is constructed by using a plurality of the secondary batteries 1, a bus bar is connected to the terminal body 211. The bus bar is used for connecting the plurality of the secondary batteries 1 in series or parallel.

The terminal body 211 is mounted on the terminal pedestal 212, and the terminal pedestal 212 is fixed on the lid 12. The terminal pedestal 212 is made of an insulating material such as resin. One end of the terminal lead 213 is connected to the terminal body 211, and the other end of terminal lead 213 is connected to the fixing member 214.

The terminal lead 213 is made of an electrically conducting material such as metal. An insulator is disposed between the terminal lead 213 and the lid 12, and the terminal lead 213 and the lid 12 are in an insulating state. As the material of the insulator, the resin such as a tetrafluoroethylene-perfluoroalkylvinylether copolymer (PFA) or a polyphenylene sulfide (PPS) can be used.

The fixing member 214 is made of an electrically conducting material such as metal and passes through the lid 12. The insulator is disposed between the fixing member 214 and the lid 12. The fixing member 214 and the lid 12 are in an insulating state.

A part of the fixing member 214 that is located outside the battery case 10 is connected to the terminal lead 213. Crimping can he used as a connection method between the fixing member 214 and the terminal lead 213, for example. A part of the fixing member 214 that is located inside the battery case 10 is connected to the current cutoff valve 25. Welding can be used as a connection method between the fixing member 214 and the current cutoff valve 25, for example.

The current cutoff valve 25 is made of an electrically conducting material such as metal and has a bending portion 25a. The bending portion 25a is connected to the negative electrode tab 23. Welding can be used as the connection method between the bending portion 25a and the negative electrode tab 23, for example.

The lid 12 has a through-hole 12a, and an auxiliary terminal 26 is inserted into the through-hole 12a. The auxiliary terminal 26 is made of an electrically conducting material such as metal. One end 26a of the auxiliary terminal 26 protrudes toward the outside of the battery case 10, and the other end 26b of the auxiliary terminal 26 protrudes toward the inside of the battery case 10.

An insulator 27 is disposed between the auxiliary terminal 26 and the through-hole 12a. The insulator 27 can be made of resin or rubber, for example. The auxiliary terminal 26 and the lid 12 can be in the insulating state by the placement of the insulator 27 between the auxiliary terminal 26 and the through-hole 12a. Additionally, a space between the auxiliary terminal 26 and the through-hole 12a can be sealed by elastic deformation of the insulator 27.

The end 26b of the auxiliary terminal 26 is connected to the negative electrode tab 23. Crimping or welding can be used as the connection method between the auxiliary terminal 26 and the negative electrode tab 23, for example. When the auxiliary terminal 26 is made of the same material as the negative electrode tab 23, the negative electrode tab 23 and the auxiliary terminal 26 can easily be welded together, for example. The auxiliary terminal 26 is disposed at a position adjacent to the negative electrode terminal 21 and on an outer edge side of the lid 12 with respect to the negative electrode terminal 21. The auxiliary terminal 26 can be fixed to the lid 12 and then connected to the negative electrode tab 23.

The position where the auxiliary terminal 26 is disposed is not limited to the position shown in FIG. 5 and can appropriately be set. In other words, the auxiliary terminal 26 may be disposed at the position where the auxiliary terminal 26 can be connected to the negative electrode tab 23. For example, the auxiliary terminal 26 can be disposed on a side of the positive electrode terminal 22 (on a left side in FIG. 5) with respect to the negative electrode terminal 21. When the assembled battery is constructed by arranging the plurality of the secondary batteries in one direction, the auxiliary terminal 26 is preferably disposed at the position shown in FIG. 5.

The auxiliary terminal 26 becomes easily accessible from the outside of the assembled battery by disposing the auxiliary terminal 26 at the position shown in FIG. 5. For example, as described below, when the auxiliary terminal 26 is connected to the load, wiring can easily be connected to the auxiliary terminal 26. If the auxiliary terminal 26 is disposed on the side of the positive electrode terminal 22 with respect to the negative electrode terminal 21, the auxiliary terminal 26 may become hardly accessible from the outside of the assembled battery in some cases due to the presence of the negative electrode terminal 21. According to the present embodiment, the auxiliary terminal 26 is disposed at a corner of the battery case 10, and therefore the auxiliary terminal 26 becomes easily accessible.

Additionally, the auxiliary terminal 26 is disposed at the position shown in FIG. 5, and thus the auxiliary terminal 26 can be mounted easily. If the auxiliary terminal 26 is disposed on the side of the positive electrode terminal 22 with respect to the negative electrode terminal 21, the auxiliary terminal 26 may hardly be mounted during the mounting of the auxiliary terminal 26 in some cases due to interference with the negative electrode terminal 21. In the present embodiment, the auxiliary terminal 26 is disposed on the outer edge side of the lid 12 with respect to the negative electrode terminal 21, and therefore the auxiliary terminal 26 can be mounted without the interference with the negative electrode terminal 21.

The auxiliary terminal 26 is connected to the negative electrode tab 23, and therefore the auxiliary terminal 26 can support the negative electrode tab 23. When a vibration or a shock is applied to the secondary battery 1 from the outside, the vibration or the shock is also transferred to the negative electrode tab 23. When the negative electrode tab 23 moves due to the vibration or the like, a load may possibly be applied to a connecting part between the negative electrode tab 23 and the current cutoff valve 25, or a load may possibly be applied to a connecting part between the negative electrode tab 23 and the power generation element 30. Furthermore, the vibration may be transferred to the current cutoff valve 25 through the negative electrode tab 23, the load may possibly be applied to the current cutoff valve 25.

As the present embodiment, the auxiliary terminal 26 supports the negative electrode tab 23, and thus the vibration in the negative electrode tab 23 and the like can be prevented. Consequently, the load can be prevented from being applied to the current cutoff valve 25 and the like.

When the Secondary battery 1 is charged and discharged, an electric current flows along a path shown with a dotted line in FIG. 5 (one example). For example, when the secondary battery 1 is charged, the electric current flows in the order of the negative electrode tab 23, the current cutoff valve 25, the fixing member 214, the terminal lead 213, and the terminal body 211. When the secondary battery 1 is discharged, the electric current flows in the direction opposite to the direction in which a charging current flows. That is to say, the electric current flows in the order of the terminal body 211, the terminal lead 213, the fixing member 214, the current cutoff valve 25, and the negative electrode tab 23. The current cutoff valve 25 becomes a part of the current path during the charging and discharging of the secondary battery 1.

When the gas is generated inside the battery case 10 by the overcharge of the secondary battery 1, the internal pressure of the battery case 10 rises. Consequently, as shown in FIG. 6, a pressure P acts on the current cutoff valve 25. When the pressure P acts on the current cutoff valve 25, the connecting part between the current cutoff valve 25 and the negative electrode tab 23 breaks due to the deformation of the current cutoff valve 25, and the current cutoff valve 25 comes off the negative electrode tab 23.

When the current cutoff valve 25 changes its state to the state shown in FIG. 6, the current cutoff valve 25 is maintained in the state shown in FIG. 6. In other words, the current cutoff valve 25 irreversibly changes its state from the state shown in FIG. 5 to the state shown in FIG. 5. Consequently, the state in which the electric current is cut off can be sustained. The pressure P when the current cutoff valve 25 is operated can be appropriately determined in consideration of the pressure-resistant performance of the battery case 10 and the like.

The current cutoff valve 25 and the negative electrode tab 23 become the current paths for charging and discharging the secondary battery 1 by using the negative electrode terminal 21, and thus the charging and the discharging of the secondary battery 1 is inhibited since the current cutoff valve 25 comes off the negative electrode tab 23. The overcharge of the secondary battery 1 can be prevented from proceeding by the inhibition on the charging and the discharging of the secondary battery 1, and the internal pressure of the battery case 10 can be prevented from rising further.

After the current cutoff valve 25 operates, the secondary battery 1 cannot be discharged by using the negative electrode terminal 21. The secondary battery 1 is in an overcharge state when the current cutoff valve 25 operates, and thus a large amount of electric energy is held stored in the power generation element 30.

In the present embodiment, by using the auxiliary terminal 26, the electric energy stored in the power generation element 30 can be output to the outside of the secondary battery 1. Even after the current cutoff valve 25 comes off the negative electrode tab 23, the auxiliary terminal 26 is connected to the power generation element 30 through the negative, electrode tab 23. Thus, when the auxiliary terminal 26 and the positive electrode terminal 22 are connected to the load, the power generation element 30 can be discharged.

The load may be anything that can consume the electric power of the power generation element 30. When the power generation element 30 is discharged, the electric current can simply flow into a resistor as the load. Additionally, electronic equipment is used as the load, and the electric power of the power generation element 30 can be used to operate the electronic equipment.

By discharging the power generation element 30 with the auxiliary terminal 26, it is prevented that the secondary battery 1 is left standing in the state in which the electric energy is held stored in the power generation element 30. When the electric power of the power generation element 30 is used to operate the electronic equipment, the electric energy stored in the power generation element 30 can be used effectively.

Since the end 26a of the auxiliary terminal 26 protrudes to the outside of the battery case 10, the temperature of the power generation element 30 can be adjusted by using the auxiliary terminal 26. Since the auxiliary terminal 26 is connected to the power generation element 30 through the negative electrode tab 23, when the temperature of the auxiliary terminal 26 is adjusted, the temperature of the power generation element 30 can be adjusted.

For example, when the power generation element 30 produces heat, the heat of the power generation element 30 is transferred not only to the negative electrode terminal 21 but also to the auxiliary terminal 26, and the heat can be emitted in the atmosphere from the negative electrode terminal 21 and the auxiliary terminal 26. If fins are provided to the end 26a of the auxiliary terminal 26, heat dissipation of the auxiliary terminal 26 can be improved.

A heat exchange medium for cooling can be brought into contact with the auxiliary terminal 26. Gas or liquid can be used as the heat exchange medium. When the auxiliary terminal 26 is cooled with the heat exchange medium, the power generation element 30 can be cooled through the negative electrode tab 23, and the temperature rise of the power generation element 30 can be prevented. If fins are provided to the end 26a of the auxiliary terminal 26, cooling efficiency of the auxiliary terminal 26 can be improved.

When the power generation element 30 is overcooled, a heat exchange medium for heating can be brought into contact with the auxiliary terminal 26. When the auxiliary terminal 26 is heated, the power generation element 30 can be heated through the negative electrode tab 23, and the temperature fall of the power generation element 30 can be prevented. If fins are provided to the end 26a of the auxiliary terminal 26, heat-receiving efficiency of the auxiliary terminal 26 can he improved, and the power generation element 30 can be heated efficiently.

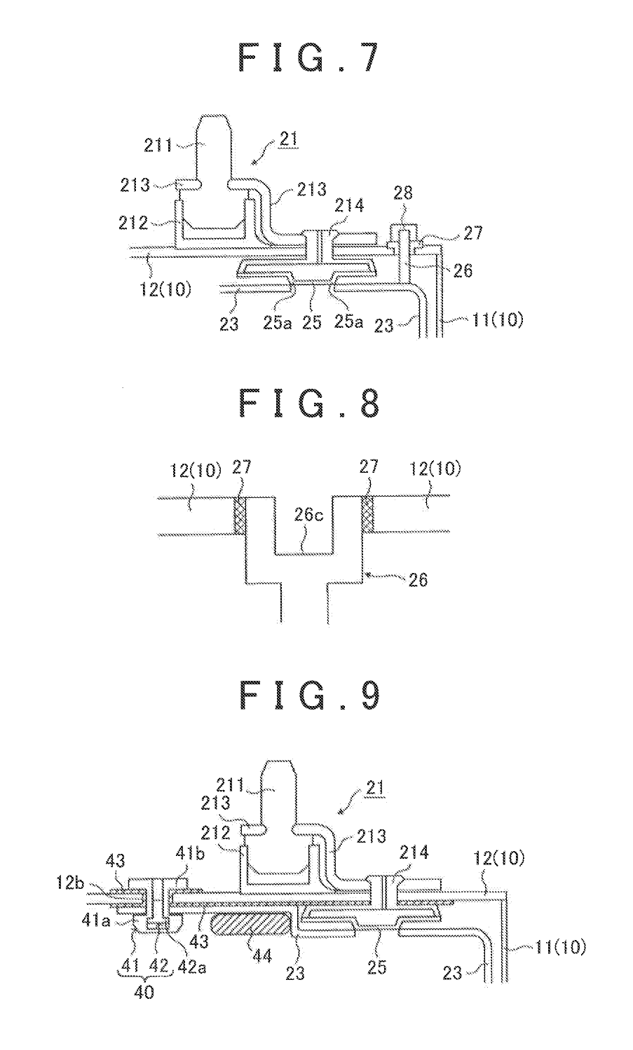

The auxiliary terminal 26 is used after the current cutoff valve 25 operates. Thus, when the secondary battery 1 is charged and discharged by using the negative electrode terminal 21, the auxiliary terminal 26 can be covered with a cover 28 as shown in FIG. 7. The cover 28 can be made of insulating materials.

More specifically, a part of the auxiliary terminal 26 exposed to the outside of the battery case 10 can be covered with the cover 28. When the auxiliary terminal 26 is used, the cover 28 may be removed. The cover 28 may be anything that covers the auxiliary terminal 26. For example, only insulating tape as the cover 28 may be attached to the auxiliary terminal 26.

The auxiliary terminal 26 exposed to the outside of the battery case 10 can be shaped into a shape to which the wiring used for the connection with the load is easily attached. For example, a projection and a depression can be formed on an outer surface of the auxiliary terminal 26. The wiring can be easily attached by using projecting and depressing surfaces of the auxiliary terminal 26. The projecting and depressing surfaces can be formed with a thread groove, for example.

In the present embodiment, a part of the auxiliary terminal 26 (end 26a) is protruded to the outside of the battery case 10; however, the auxiliary terminal 26 may not be protruded to the outside of the battery case 10. For example, the auxiliary terminal 26 shown in FIG. 8 can be used. In FIG. 8, an end face of the auxiliary terminal 26 is disposed along an outer surface of the lid 12, and the auxiliary terminal 26 does not protrude to the outside of the battery case 10. The auxiliary terminal 26 is used for the connection with the load and thus exposed to the outside of the battery case 10.

The auxiliary terminal 26 has a groove 26c. As a result of providing the groove 26c to the auxiliary terminal 26, the wiring used for the connection with the load can be inserted into the groove 26c, and the wiring and the auxiliary terminal 26 can be connected to each other. When the thread groove is formed in an inner wall surface of the groove 26c here, the wiring and the auxiliary terminal 26 can easily be connected to each other. More specifically, the thread groove that meshes with the thread groove of the groove 26c can be provided at the end of the wiring.

In the structure shown in FIG. 8, when the secondary battery 1 is charged and discharged by using the negative electrode terminal 21, the auxiliary terminal 26 can be covered with a cover 28 also. The auxiliary terminal 26 does not protrude to the outside of the battery case 10, and thus the insulating tape can easily be attached when the insulating tape is used as the cover 28.

In the present embodiment, the auxiliary terminal 26 is mounted in the lid 12; however, the auxiliary terminal 26 may be mounted on the case body 11. Additionally, a connecting position between the auxiliary terminal 26 and the negative electrode tab 23 is not limited to the position shown in FIG. 5. More specifically, the connecting position between the auxiliary terminal 26 and the negative electrode tab 23 may be located between the connecting position between the current cutoff valve 25 and the negative electrode tab 23 and the connecting position between the negative electrode tab 23 and the power generation element 30. Consequently, even after the current cutoff valve 25 comes off the negative electrode tab 23, the power generation element 30 can be discharged by using the auxiliary terminal 26.

In the present embodiment, the current cutoff valve 25 is provided to the negative electrode terminal 21; however, the current cutoff valve 25 may be provided to the positive electrode terminal 22. Since the positive electrode terminal 22 has the similar structure to the negative electrode terminal 21, when the current cutoff valve 25 is provided to the positive electrode terminal 22, the similar structure to the present embodiment can be applied. The current cutoff valve 25 may be provided to at least one of the negative electrode terminal 21 and the positive electrode terminal 22.

In the present embodiment, the current cutoff valve 25 is used as a mechanism for cutting off the electric current; however, the present invention is not limited to this. The current cutoff mechanism may be capable of interrupting the current path between the negative electrode terminal 21 (or positive electrode terminal 22) and the power generation element 30. In the present embodiment, the electric current is cut off by the deformation of the current cutoff valve 25; however, the electric, current can be cut off with a fuse and the like. For example, when the overcharge of the secondary battery 1 is detected, the fuse can be blown by feeding the electric current through the fuse.

In the present embodiment, the current cutoff valve 25 irreversibly changes its state from a conduction state to a current cutoff state; however, the present invention is not limited to this. That is to say, the current cutoff valve 25 may change its state between the conduction state and the current cutoff state. Even in this case, when the current cutoff valve 25 is maintained in the current cutoff state, after the secondary battery 1 is overcharged, the charging and the discharging of the secondary battery 1 by using the negative electrode terminal 21 can be inhibited. When the current cutoff valve 25 is in the current cutoff state, the power generation element 30 can be discharged by using the auxiliary terminal 26.

### Second Embodiment

The secondary battery that is the second embodiment of the present invention is described with reference to FIG. 9. FIG. 9 is an enlarged view that shows the structure of a part of the secondary battery and corresponds to FIG. 1 according to the first embodiment. In the present embodiment, the same reference numerals and symbols are given to the same member as that described in the first embodiment, and the detailed description thereof is not repeated. Hereinafter, different points from the first embodiment will be principally described.

The lid 12 has a through-hole 12b. The through-hole 12b is used for filling the inside of the battery case 10 with the electrolyte solution. The power generation element 30 is housed in the case body 11, the lid 12 is fixed on the case body 11, and then the electrolyte solution is filled into the battery case 10. The electrolyte solution can be impregnated into the separator 33 and the active material layers 31b, 32b by filling the electrolyte solution into the battery case 10.

After the electrolyte solution is filled into the battery case 10, the through-bole 12b is sealed with an auxiliary terminal 40. The auxiliary terminal 40 is made of an electrically conducting material such as metal. The auxiliary terminal 40 can be connected to the negative electrode tab 23 as described below, and thus the auxiliary terminal 40 can be made of the same material as the negative electrode tab 23. An insulator 43 is disposed between the auxiliary terminal 40 and the lid 12, and the auxiliary terminal 40 and the lid 12 are in the insulating state.

A blind rivet can be used as the auxiliary terminal 40. The auxiliary terminal 40 as the blind rivet has a rivet body 41 and a shaft 42. The shaft 42 is disposed inside the rivet body 41. Both ends 41a, 41b of the rivet body 41 are crimped and extend in a direction along the lid 12.

Before the auxiliary terminal 40 is crimped, the end 41a of the rivet body 41 has the size in which it can pass through the through-hole 12b. After the end 41a of the rivet body 41 passes through the through-hole 12b, the end 41b of the rivet body 41 is crimped, and thus the end 41b can be formed into the shape shown in FIG. 9.

Additionally, after the end 41a of the rivet body 41 passes through the through-hole 12b, the shaft 42 is slid, the end 41a of the rivet body 41 is crimped, and thus the end 41a can be formed into the shape shown in FIG. 9. When the end 41a of the rivet body 41 is crimped, the shaft 42 protrudes from the rivet body 41, and the shaft 42 can be slid by pulling a protruding portion of the shaft 42.

The shaft 42 has a flange section 42a, and thus the end 41a of the rivet body 41 is deformed by the movement of the flange section 42a associated with the slide of the shaft 42 to be formed into the shape shown in FIG. 9. After the shaft 42 is slid, the shaft 42 is cut. The shaft 42 shown in FIG. 9 represents the shaft after being cut.

The through-hole 12b can be sealed by crimping the ends 41a, 41b of the rivet body 41. As shown in FIG. 9, the ends 41a, 41b of the rivet body 41 hold the lid 12 and the negative electrode tab 23 therebetween. Consequently, the negative electrode tab 23 can be fixed to the auxiliary terminal 40. The insulator 43 is disposed between the negative electrode tab 23 and the lid 12, and the negative electrode tab 23 and the lid 12 are in the insulating state. Additionally, the negative electrode tab 23 is held by an insulator 44 and disposed along the lid 12.

Since the insulator 43 is disposed between the auxiliary terminal 40 and the lid 12, sealability between the auxiliary terminal 40 and the lid 12 can be secured by the elastic deformation of the insulator 43. In the present embodiment, the blind rivet is used as the auxiliary terminal 40; however, the present invention is not limited to this. In other words, the auxiliary terminal 40 can be used to block the through-hole 12b.

In the secondary battery 1 according to the present embodiment, when the secondary battery 1 is charged and discharged by using the negative electrode terminal 21, the electric current flows into the current path including the current cutoff valve 25. On the other hand, when the internal pressure of the battery case 10 rises, the current cutoff valve 25 comes off the negative electrode tab 23, and the current path including the current cutoff valve 25 is interrupted.

After the current cutoff valve 25 operates, the negative electrode tab 23 is connected to the auxiliary terminal 40. Thus, when the auxiliary terminal 40 and the positive electrode terminal 22 are connected to the load, the power generation element 30 can be discharged. Consequently, the same effect as the first embodiment can be obtained.

The auxiliary terminal 40 has a function that blocks the through-hole 12b used in filling the electrolyte solution and a function as a terminal used in discharging the power generation element 30. The number of parts count can be prevented from increasing and the cost can be reduced by providing two functions to the auxiliary terminal 40. When the auxiliary terminal 26 described in the first embodiment is used, in addition to the through-hole 12b used in filling the electrolyte solution, the through-hole 12a for passing the auxiliary terminal 26 is required to be formed in the lid 12. In the present embodiment, only one through-hole may be formed in the lid 12, and thus the sealability of the battery case 10 can easily be secured.

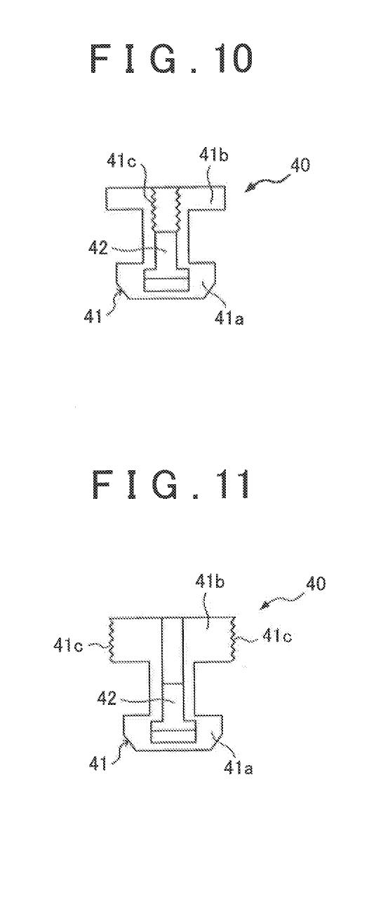

In the present embodiment, the auxiliary terminal 40 shown in FIG. 10 or FIG. 11 can be used. FIG. 10 and FIG. 11 show the auxiliary terminal 40 after being crimped. The blind rivet is used as the auxiliary terminal 40.

In the auxiliary terminal 40 shown in FIG. 10, a thread groove 41c is formed in an inner wall surface of the rivet body 41. In the auxiliary terminal 40 shown in FIG. 11, the thread groove 41c is formed in the end 41b of the rivet body 41. As a result of forming the thread groove 41c in the rivet body 41, when the auxiliary terminal 40 is connected to the load, the wiring can easily be connected to the auxiliary terminal 40.

1. A secondary battery including a current path, the secondary battery comprising:
a power generation element configured to charge and discharge:
a battery case configured to house the power generation element;
an electrode terminal exposed in an outer surface of the battery case, the electrode terminal electrically connected to the power generation element;
a current cutoff mechanism disposed inside the battery case, the current cutoff mechanism disposed on the current path connecting between the power generation element and the electrode terminal, and the current cutoff mechanism configured to cut off an electric current; and
an auxiliary terminal electrically connected to a current path positioned between the power generation element and the current cutoff mechanism of the current path, the auxiliary terminal exposed in the outer surface of the battery case.

2. The secondary battery according to claim 1,
wherein the current cutoff mechanism is configured to irreversibly change from a conduction state to a state in which the electric current is cut off.

3. The secondary battery according to claim 1,
wherein the current cutoff mechanism includes a valve, and
the valve is configured to deform in response to a rise in internal pressure of the battery case to cut off the electric current.

4. The secondary battery according to claim 1,
wherein the battery case includes a through-hole that is used in filling an electrolyte solution, and
the auxiliary terminal blocks the through-hole.

5. The secondary battery according to claim 4,
wherein the auxiliary terminal is a blind rivet.

6. The secondary battery according to claim 1, further comprising:
a cover configured to cover an area of the auxiliary terminal that is exposed in the outer surface of the battery case, the cover being made of an insulating material.

7. The secondary battery according to claim 1,
wherein the auxiliary terminal includes a projection part and a depression part in an area that is exposed in the outer surface of the battery case.

8. The secondary battery according to claim 1,
wherein the battery case includes a case body and a lid,
the case body has a substantially rectangular parallelepiped shape,
the lid and the case body define a space housing the power generation element, and
the electrode terminal and the auxiliary terminal are fixed in the lid.

9. The secondary battery according to claim 8,
wherein the auxiliary terminal is disposed on an outer edge side of the lid with respect to the electrode terminal.
